(19) United States
(12) Patent Application Publication
(10) Pub. No.: US 2011/0048912 A1
(43) Pub. Date: Mar. 3, 2011

(54) COMPOSITE ROTARY SWITCH

(75) Inventors: KOJI YASUDA, Osaka (JP); TAKESHI UEDA, Osaka (JP)

(73) Assignee: PANASONIC CORPORATION, Osaka (JP)

(21) Appl. No.: 12/860,993

(22) Filed: Aug. 23, 2010

(30) Foreign Application Priority Data
Aug. 26, 2009 (JP) 2009-194941

(51) Int. Cl. H01H 19/02

(52) U.S. Cl. 200/5 A

(57) ABSTRACT

A composite rotary switch includes a first rotary operation member configured to be rotatable around a rotational center, a second rotary operation member configured to be rotatable around the rotational center, an electrical position detector operable to electrically detect a rotational position of the first rotary operation member, and an optical position detector operable to optically detect a rotational position of the second rotary operation member.

### BACKGROUND

1. Technical Field

The technical field relates to a rotary switch and more particularly to a composite rotary switch including a plurality of rotary operation members of which rotational position can be detected.

2. Related Art

Various types of apparatuses are proposed that detect a position indicated by an operation member when the operation member is operated, including, for example, one using an electric contact, one using a change in electrical resistance, and one using reflection of light. For example, JP 56-111421 A discloses an apparatus that optically detects a position of an operation member.

Recently, amazing technological advances have been made in a field of an imaging apparatus such as a digital still camera, and the imaging apparatus which is small in size but implements various functions has been put on the market. In addition, products directed for users, such as professionals skilled in shooting techniques and high level amateurs, are provided with a number of operation members on the top and back surfaces of the apparatus so that the users can enjoy manual operations.

To improve the operability of the operation members, it is desirable to arrange the operation members on a top surface of an imaging apparatus. However, on the top surface of the imaging apparatus, a pop-up type electronic flash, a hot shoe for attaching external accessories, various dials, and switches are already arranged. Hence, it is difficult to provide new operation members on the top surface of the imaging apparatus.

In particular, it is very difficult to provide additional operation members on the exterior of the imaging apparatus while satisfying a demand for miniaturization of the imaging apparatus.

To solve the above-described problem, a rotary switch is provided that can be arranged even in a small area such as a top surface of an imaging apparatus.

### SUMMARY

In one aspect, a composite rotary switch includes a first rotary operation member configured to be rotatable around a rotational center, a second rotary operation member configured to be rotatable around the rotational center, an electrical position detector operable to electrically detect a rotational position of the first rotary operation member, and an optical position detector operable to optically detect a rotational position of the second rotary operation member.

According to the composite rotary switch in one aspect, the two rotary operation members are allowed to have the same rotational center and the rotational positions of the two rotary operation members can be detected independently, and thus additional operation members can be arranged even in a small area. Furthermore, optically detecting a rotational position of one rotary operation member allows the problem of contact failure of an electrical position detector to be improved, the number of components to be reduced, and furthermore, an improvement in reliability to also be achieved. Due to the above-described points, miniaturization and reduction in cost of a rotary switch can be achieved.

### BRIEF DESCRIPTION OF DRAWINGS

FIG. 1 is a perspective view of a digital still camera according to an embodiment.

FIGS. 2A to 2C are front, top, and side views of the digital still camera according to the embodiment.

FIG. 3 is a diagram showing a state in which a pop-up electronic flash is in use.

FIG. 4 is an exploded perspective view of a top surface of the digital still camera according to the embodiment.

FIG. 5 is a cross-sectional view of the top surface of the digital still camera according to the embodiment.

FIG. 6 is a diagram of a drive mode lever as seen from a top surface thereof.

FIG. 7 is a diagram showing a relation between a state of detecting reflection of a reflective photo-coupler and a drive mode.

### DETAILED DESCRIPTION OF PREFERRED EMBODIMENT

An embodiment will be described below with reference to the accompanying drawings.

### 1. Configuration of Digital Still Camera

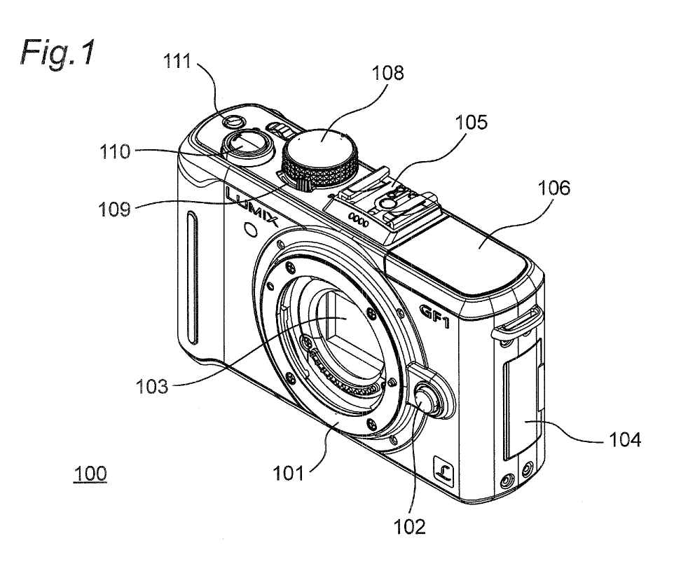

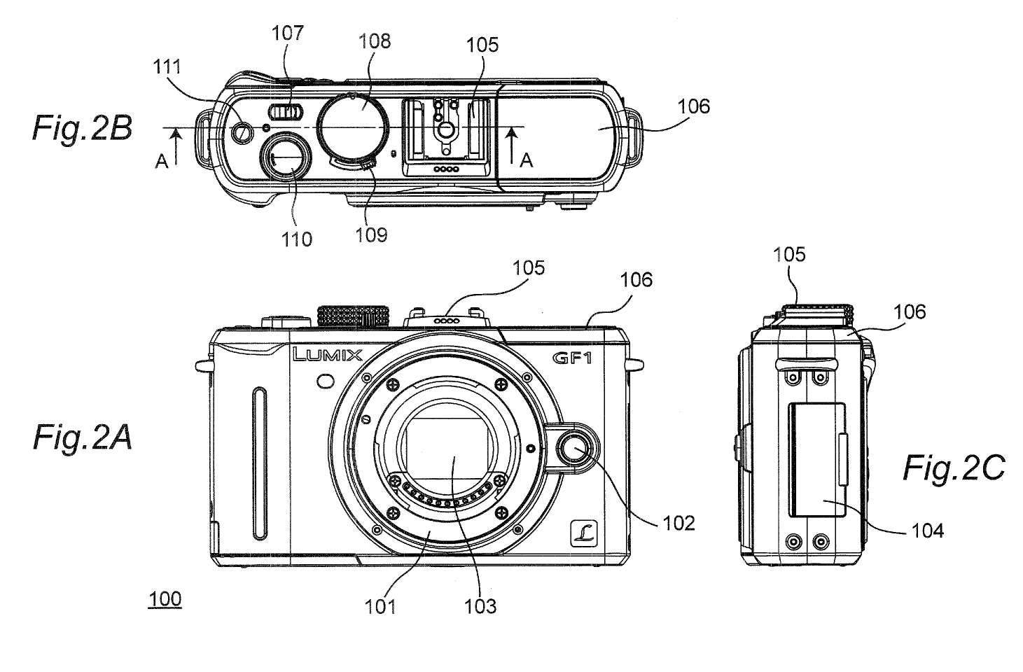

FIG. 1 is a perspective view of a digital still camera including a composite rotary switch. FIGS. 2A to 2C are three views of the digital still camera according to the embodiment. FIG. 2A is a front view, FIG. 2B is a top view, and FIG. 2C is a right side view of the digital still camera when the camera is seen from the front side.

An interchangeable lens (not shown) is attachable to a digital still camera 100 through a mount 101. FIGS. 1 and 2A to 2C show a state in which the interchangeable lens is detached from the digital still camera 100. The interchangeable lens can be attached to the digital still camera 100 by inserting a mount of the interchangeable lens into the mount 101 of the digital still camera 100 and rotating the interchangeable lens clockwise. The interchangeable lens can be detached from the digital still camera 100 by rotating the interchangeable lens counterclockwise while pressing an interchangeable lens detach button 102. An imaging device 103 provided inside the digital still camera 100 can be seen through an opening of the mount 101.

As shown in FIG. 2C, a terminal cover 104 that covers various terminals is provided on a right side of a body of the digital still camera 100. FIGS. 1 and 2A to 2C show a state in which the terminal cover 104 is closed. HDMI terminals for displaying an image on a television set, USB terminals for transferring images to a computer, and so on are contained inside the terminal cover 104.

A number of operation members, a hot shoe 105, and a pop-up electronic flash 106 are arranged on a top surface of the body of the digital still camera 100.

Accessories such as an external electronic flash with a large amount of light emission, one of various finders, and a high performance external microphone can be attached to the hot shoe 105. To fix accessories having a certain size and weight, the hot shoe 105 requires a certain size and strength. Therefore, the hot shoe 105 is often configured by a metal member. In addition, to obtain optimum light distribution by an external electronic flash, there is a constraint that the hot shoe 105 needs to be provided on the top surface of the digital still camera 100 and directly above the optical axis. Furthermore, to establish an electrical connection between the digital still camera 100 and various accessories, the hot shoe 105 is provided with a plurality of electric contacts.

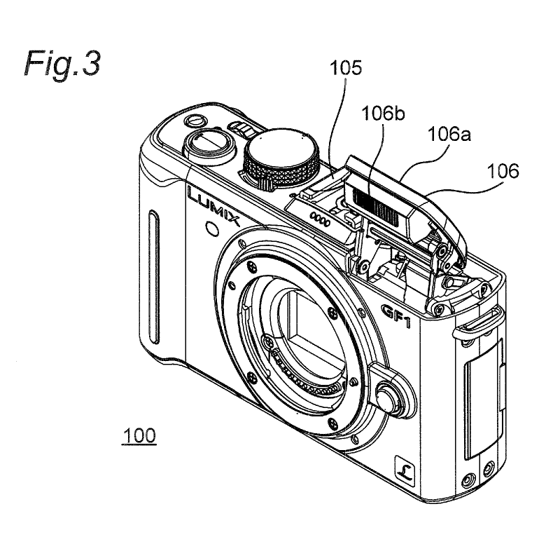

The pop-up electronic flash 106 is an electronic flash apparatus included in the digital still camera 100. When the pop-up electronic flash 106 is not in use, as shown in FIGS. 1 and 2A to 2C, the pop-up electronic flash 106 is contained in the digital still camera 100. FIG. 3 is a diagram showing a state in which the pop-up electronic flash 106 is in use. In FIG. 3, those reference numerals unnecessary to describe the pop-up electronic flash 106 are omitted. In the state in which the pop-up electronic flash 106 is in use, a pop-up electronic flash cover 106a rises at an angle of substantially 45° in a back direction of the digital still camera 100. By this, an electronic flash light emitter 106h appears. Therefore, it is difficult provide operation members on a top surface of the pop-up electronic flash cover 106a.

As described above, substantially half the top surface of the digital still camera 100 is occupied by the hot shoe 105 and the pop-up electronic flash 106. As a result, a number of operation members are crammed into substantially the other half of the top surface of the digital still camera 100.

Referring back to FIG. 2B, the operation members arranged on the top surface of the body of the digital still camera 100 include a power switch 107, a recording mode dial 108, a drive mode lever 109, a shutter button 110, and a menu button 111.

The power switch 107 is an operation member for turning on or off the power to the digital still camera 100 by performing a slide operation. A slide type operation member is adopted to avoid accidental power-on/off. Hence, the area occupied by the power switch 107 is about double the area of the menu button 111.

The recording mode dial 108 is a rotary operation member for determining a recording mode. The recording mode of the digital still camera 100 includes an auto recording mode (“iA” shown on a top surface of the recording mode dial 108), a program recording mode (“P” is shown likewise), an aperture priority recording mode (“A” is shown likewise), a shutter speed priority recording mode (“S” is shown likewise), a manual recording mode (“M” is shown likewise), and so on. By rotating the recording mode dial 108, the recording mode can be switched. Since the recording mode dial 108 is a rotary operation member, a certain size is required to enhance operability.

The drive mode lever 109 is a lever type operation member for determining a drive mode. The drive mode of the digital camera 100 includes a single shooting mode for taking a single image by pressing operation performed on the shutter button 110, a continuous shooting mode for taking a plurality of images continuously while the shutter button 110 is pressed, an auto bracket mode for taking a plurality of images while exposure is varied when pressing the shutter button 110, a self-timer mode for taking an image when a predetermined period of time elapses after the shutter button 110 is pressed, and so on. Rotating of the drive mode lever 109 can switch the drive mode. The drive mode lever 109 is arranged below the recording mode dial 108 and has the same rotational center as the recording mode dial 108. Therefore, the drive mode lever 109 does not occupy the area of the top surface of the digital still camera 100 almost at all.

The shutter button 110 is a button-type operation member for providing a trigger for shooting. Shooting is performed by sliding the power switch 107 to turn on the digital still camera 100, rotating the recording mode dial 108 to determine a recording mode, rotating the drive mode lever 109 to determine a drive mode, and pressing the shutter button 110. The shutter button 110 is an important operation member for providing a trigger for shooting, and the operability of the shutter button 110 greatly affects the usability of the digital still camera 100. Thus, the shutter button 110 which is considerably larger than the menu button 111 is used.

The menu button 111 is a button-type operation member for changing other setting items. When the menu button 111 is pressed, setting items are displayed on a liquid crystal monitor (not shown) provided on the back of the digital still camera 100. The setting items displayed on the liquid crystal monitor upon press of the menu button 111 include a size of an image to be recorded, white balance, ISO sensitivity, an operating mode of auto-focus, a light emission mode of the pop-up electronic flash 106, and so on. These setting items cannot be changed by rotating the recording mode dial 108 or rotating the drive mode lever 109. However, the frequency of changing the setting item is low, and thus a button-type operation member which is relatively small is adopted for the menu button 111.

### 2. Composite Rotary Switch

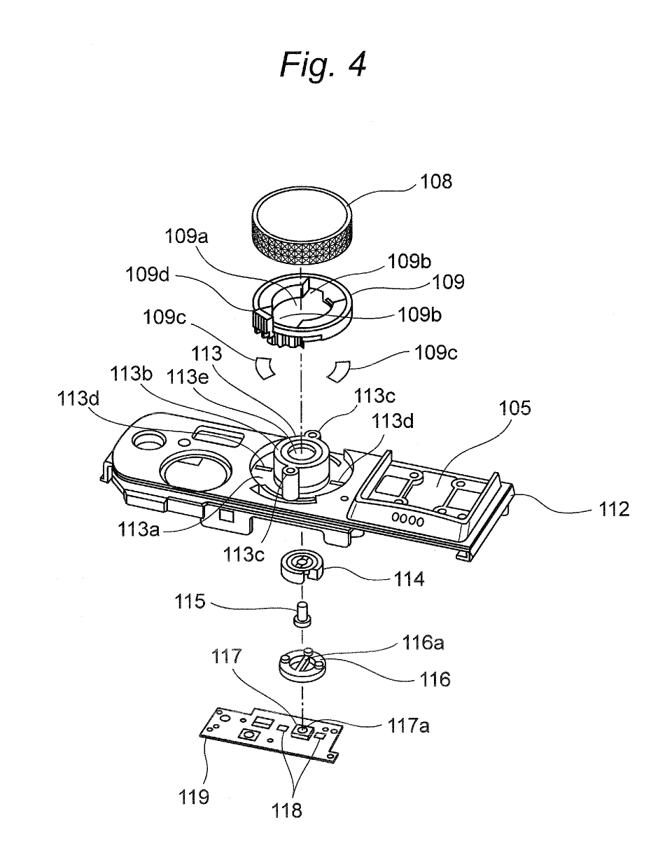

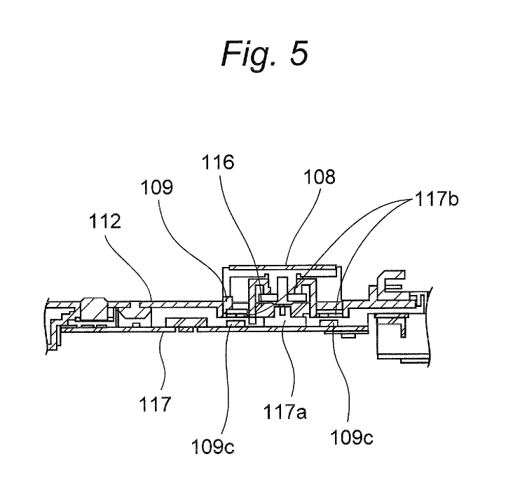

FIG. 4 is an exploded perspective view of the top surface of the digital still camera 100 including a composite rotary switch. FIG. 5 is a cross-sectional view of the top surface of the digital still camera 100. FIG. 5 shows an A-A cross section of FIG. 25.

The composite rotary switch according to the present embodiment includes the recording mode dial 108, a detector 117 for electrically detecting a rotational position of the recording mode dial 108, the drive mode lever 109, and a detector 109c and 118 for optically detecting a rotational position of the drive mode lever 109.

### 2.1 Composite Rotary Switch Mounting Section

A composite rotary switch mounting section 113 is formed on a top surface cover 112 of the digital still camera 100. The composite rotary switch mounting section 113 includes a recess 113a on which the drive mode lever 109 is placed, a cylindrical member 113b which is inserted through a circular opening 109a of the drive mode lever 109, a pair of stoppers 113c which are inserted into a pair of fan-shaped openings 109b of the drive mode lever 109, a pair of light flux passing portions 113d that allow light flux which is emitted from a pair of reflective photo-couplers 118 and is reflected by a pair of reflector plates 109c bonded to the back side of the drive mode lever 109 to pass through the light flux passing portion 113d, and a rotating shaft hole 113e that allows a rotating shaft 115 providing the rotational center of the recording mode dial 108 to be inserted through the rotating shaft hole 113e.

### 2.2 Recording Mode Dial

The recording mode dial 108 is fixed to the rotating shaft 115 which is inserted through a rotor coupling plate 114 and the rotating shaft hole 113e. The rotor coupling plate 114 has functions of preventing the recording mode dial 108 from dropping out of the rotating shaft 115, and of coupling the recording mode dial 108 to a rotary switch rotor 116. A groove is made at the lower portion of the rotor coupling plate 114, which engages with the convex part of the rotary switch rotor 116. A rotating portion 117a of a rotary switch 117 also has a groove cut therein, and the groove engages with the rail 116a provided at the center of the rotary switch rotor 116. The rotary switch rotor 116 is configured to be able to absorb an error for alignment among the recording mode dial 108, the rotor coupling plate 114, and the rotary switch 117 mounted on a switch board 119.

Therefore, when the recording mode dial 108 is rotated, the rotating portion 117a of the rotary switch 117 rotates. The rotary switch 117 is a switch capable of electrically detecting a rotation angle of the rotating portion 117a. The rotary switch 117 is mounted on the switch board 119. The switch board 119 is connected to a main board (not shown) by a flexible cable (not shown). A CPU mounted on the main board can recognize the recording mode which is selected by the recording mode dial 108, by electrically detecting a rotation angle of the rotating portion 117a of the rotary switch 117.

Note that the structure of the recording mode dial 108 described above is one example and is not limited thereto. The recording mode dial 108 can have any structure as long as it is an electrical position detector that can electrically detect a rotational position (indicated position) of the rotary operation member.

### 2.3 Drive Mode Lever

The drive mode lever 109 is inserted through the cylindrical member 113b and is placed in the recess 113a. The drive mode lever 109 is provided under the recording mode dial 108 and has a knob 109d protruding from an outer edge of the recording mode dial 108. In addition, the rotatable range of the drive mode lever 109 is regulated by a pair of stoppers 113c inserted through a pair of fan-shaped openings 109b. For the above-described reasons, the drive mode lever 109 is referred to as “lever” but does not essentially differ from “dial”.

A pair of reflector plates 109c are bonded to the back side of the drive mode lever 109. A light flux emitted from a pair of reflective photo-couplers 118 mounted on the switch board 119 passes through a pair of light flux passing portions 113d provided on the top surface cover 112 to reach the back side of the drive mode lever 109.

The position of each reflector plate 109c changes depending on the rotational position of the drive mode lever 109. When the reflector plate 109c is positioned at the position which a light flux emitted from the reflective photo-coupler 118 reaches, the light flux emitted from the reflective photo-coupler 118 is reflected by the reflector plate 109c, passes again through the light flux passing portion 113d provided in the top surface cover 112, and then reaches light-receiving portion of the reflective photo-coupler 118. On the other hand, when the reflector plate 109c is not positioned at the position which a light flux emitted from the reflective photo-coupler 118 reaches, the light flux Emitted from the reflective photo-couplers 118 does not reach the light-receiving portions of the reflective photo-couplers 118. Thus, the CPU mounted on the main board can recognize a drive mode selected by the drive mode lever 109, by monitoring outputs from the pair of reflective photo-couplers 118.

Note that the structure of the drive mode lever 109 described above is one example and is not limited thereto. The drive mode lever 109 can have any structure as long as it is an optical position detector that can optically detect a rotational position of (position indicated by) the rotary operation member. Also, it is not necessary to regulate the rotatable range.

### 2.4 Encoder of Drive Mode Lever

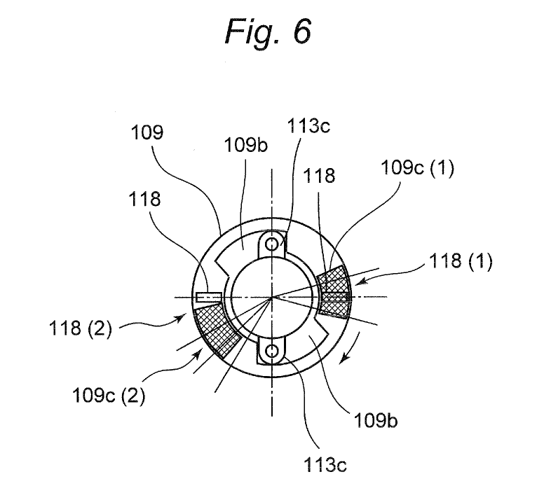

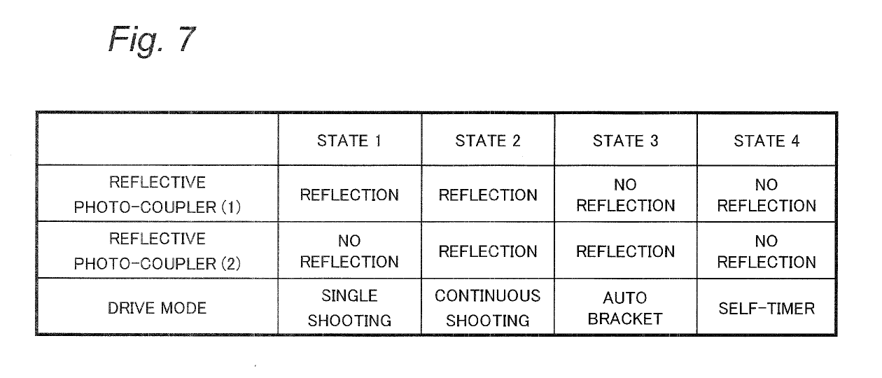

FIG. 6 is a diagram of the drive mode lever 109 as seen from a top surface thereof, in which the recording mode dial 108 is being removed. FIG. 7 is a diagram showing a correspondence between a state of reflection detection of the reflective photo-couplers 118(1) and 118(2), and the drive mode.

In FIG. 6, one end of each fan-shaped opening 109b of the drive mode lever 109 contacts on a stopper 113c. Therefore, the drive mode lever 109 cannot be further rotated counterclockwise. The state shown in FIG. 6 corresponds to state 1 shown in FIG. 7. Namely, the reflective photo-coupler 118(1) detects “reflection” but the reflective photo-coupler 118(2) detects “no reflection”. This is because although the reflector plate 109c(1) is positioned at a position of the drive mode lever 109, corresponding to the reflective photo-coupler 118(1), the reflector plate 109c(2) is not positioned at a position of the drive mode lever 109, corresponding to the reflective photo-coupler 118(2). The CPU mounted on the main board can recognize that a single shooting mode is selected by the drive mode lever 109, by monitoring the outputs from the reflective photo-couplers 118(1) and 118(2).

When the drive mode lever 109 is rotated clockwise by a constant amount from the state shown in FIG. 6, State 2 shown in FIG. 7 is set. In State 2 shown in FIG. 7, both of the reflective photo-couplers 118(1) and 118(2) detect “reflection”. This is because the reflector plate 109c(2) is also positioned at the position of the drive mode lever 109, corresponding to the reflective photo-coupler 118(2). The CPU mounted on the main board can recognize that a continuous shooting mode is selected by the drive mode lever 109, by monitoring the outputs from the reflective photo-couplers 118(1) and 118(2).

When the drive mode lever 109 is further rotated clockwise by a constant amount, State 3 shown in FIG. 7 is set. In State 3 shown in FIG. 7, the reflective photo-coupler 118(1) does not detect reflection but the reflective photo-coupler 118(2) detects reflection. This is because the reflector plate 109c(1) is not positioned at the position of the drive mode lever 109 corresponding to the reflective photo-coupler 118(1). The CPU mounted on the main board can recognize that an auto bracket mode is selected by the drive mode lever 109, by monitoring the outputs from the reflective photo-couplers 118(1) and 118(2). When the drive mode lever 109 is further rotated clockwise by a certain amount, State 4 shown in FIG. 7 is set. In this state, the other end of each fan-shaped opening 109b of the drive mode lever 109 contacts on a corresponding stopper 113c. Therefore, the drive mode lever 109 cannot be further rotated clockwise. In State 4 shown in FIG. 7, both of the reflective photo-couplers 118(1), (2) do not detect reflection. This is because the reflector plate 109c(2) is not positioned either in the position of the drive mode lever 109 corresponding to the reflective photo-coupler 118(2). The CPU mounted on the main board can recognize that a self-timer mode is selected by the drive mode lever 109, by monitoring the outputs from the reflective photo-couplers 118(1) and 118(2).

As described above, the CPU mounted on the main board can recognize a drive mode selected by the drive mode lever 109, by monitoring the outputs from the pair of reflective photo-couplers 118(1) and 118(2).

By using the pair of reflective photo-couplers 118(1) and 118(2), four states can be recognized. But if the number of states to be recognized is two, only one reflective photo-coupler may be used. Even if the number of states to be recognized is five or more, such a situation can be handled by appropriately increasing the number of reflective photo-couplers.

Furthermore, although, in the digital still camera according to the present embodiment, the pair of reflective photo-couplers 118(1) and 118(2) are arranged to be symmetrical about the rotational center, the arrangement of the reflective photo-couplers is not limited thereto. Reflective photo-couplers may be arranged on a plurality of concentric circles having different diameters, respectively, with the rotational center being the center of the concentric circles.

For the optical position detector, a photointerrupter, and so on can also be used, instead of or in addition to a reflective photo-coupler. When a photointerrupter is used, it may be configured, for example, that a shielding portion is provided on a part of the drive mode lever 109 so that a state in which the shielding portion shields between a light-emitting section and a light-receiving section of the photointerrupter and a state in which the shielding portion does not shield between the light-emitting section and the light-receiving section are created by rotating the drive mode lever 109. When the shielding portion of the drive mode lever 109 is formed in a direction toward the rotational center, the area in which the composite rotary switch is mounted does not increase compared to the case of using reflective photo-couplers. In addition, there is no need to bond the reflector plate 109c to the back side of the drive mode lever 109.

### 3. Summary

A composite rotary switch according to the present embodiment includes the recording mode dial 108 rotatable around a rotational center, the drive mode lever 109 rotatable around the rotational center, the rotary switch 117 that electrically detects a rotational position of the recording mode dial 108, and the reflector plates 109c and the reflective photo-couplers 118 that optically detect a rotational position of the drive mode lever 109. The composite rotary switch includes two operation members (the recording mode dial 108 and the drive mode lever 109) and implements a plurality of switch functions.

As described above, in the present embodiment, a rotational position of an operation member which is the drive mode lever 109 arranged to be stacked on the recording mode dial 108 is detected using an optical detector such as a photo-coupler. Generally, a rotary operation member has a structure to detect a rotational position thereof by using an electric contact formed of a brush, a conductor, and so on. Therefore, when a plurality of operation members are stacked and arranged, it needs to prevent a region of an electric contact of one operation member from being overlapped on a region of an electric contact of the other operation member. Hence, the electric contact region of one operation member needs to be arranged around the electric contact region of the other operation member, causing a problem, that the structure becomes large. In contrast to this, in the structure in the present embodiment, a rotational position of one operation member is detected using an optical detector (photo-coupler), which eliminates the need to arrange components around the other operation member. Accordingly, the number of components can be reduced and the structure of the operation members can be miniaturized. Hence, even in a small region where it is difficult to arrange more new operation members, operation members having a plurality of switch functions can be arranged. Furthermore, an optical detector performs detection in a noncontact manner and thus is superior in terms of reliability to an electrical detector that performs detection in a contact manner.

### INDUSTRIAL APPLICABILITY

The present embodiment enables to miniaturize a rotary switch having a plurality of switch functions and arrange the rotary switch even in a small region. Thus, the concept of the present embodiment is useful in, for example, a digital still camera which is small in size and requires a numbers of operation members.

What is claimed is:

1. A composite rotary switch comprising:
a first rotary operation member configured to be rotatable around a rotational center;
a second rotary operation member configured to be rotatable around the rotational center;
an electrical position detector operable to electrically detect a rotational position of the first rotary operation member; and
an optical position detector operable to optically detect a rotational position of the second rotary operation member.

2. The composite rotary switch according to claim 1, wherein the electrical position detector includes a rotary switch.

3. The composite rotary switch according to claim 1, wherein the optical position detector includes a reflective photo-coupler.

4. The composite rotary switch according to claim wherein the optical position detector includes a photointerrupter.

5. An imaging apparatus comprising a composite rotary switch according to claim 1.

6. An imaging apparatus comprising a composite rotary switch according to claim 2.

7. An imaging apparatus comprising a composite rotary switch according to claim 3.

8. An imaging apparatus comprising a composite rotary switch according to claim 4.
